(19) United States
(12) Patent Application Publication
(10) Pub. No.: US 2021/0213570 A1
(43) Pub. Date: Jul. 15, 2021

(54) Flux and Solder Paste Using the Same

(71) Applicant: Senju Metal Industry Co., Ltd., Tokyo (JP)

(72) Inventors: Yusuke Kawano, Saitama (JP); Hayato Kaise, Tokyo (JP); Syuta Akatsuka, Tokyo (JP); Kengo Ohta, Kanagawa (JP); Sakie Okada, Tokyo (JP)

(21) Appl. No.: 17/145,481

(22) Filed: Jan. 11, 2021

(30) Foreign Application Priority Data
Jan. 14, 2020 (JP) 2020-003557

(51) Int. Cl. B23K 35/36; B23K 35/362; B23K 35/02

(52) U.S. Cl. CPC B23K 35/3612; B23K 35/025; B23K 35/362

(57) ABSTRACT

Provided is flux used for soldering and solder paste using the same. The flux used for an air-dispensing method contains a solvent, a high viscosity solvent of 1, 2, 6-hexantriol and isobornyl cyclohexanol, and a thixotropic agent but does not contain rosin. The flux used for the air-dispensing method and a jet-dispensing method contains a solvent, a high viscosity solvent of 1, 2, 6-hexantriol and isobornyl cyclohexanol, a thixotropic agent and rosin.

### CROSS REFERENCE TO RELATED APPLICATION

This application claims priority to Japanese Patent Application No. 2020-003557 filed Jan. 14, 2020, the disclosure of which is hereby incorporated by reference in its entirety.

### BACKGROUND

### (1) Field of the Invention

The present invention relates to flux used for soldering and solder paste using this flux.

### (2) Description of Related Art

The flux used for the soldering generally has effects of chemically removing metal oxides present on solder and a metal surface of a joint target to be soldered and allowing movement of metal elements at the boundary between them. Therefore, by soldering using the flux, an intermetallic compound can be formed between the solder and the metal surface of the joint target, so that strong joint can be obtained.

The solder paste is a composite material obtained by adding solder alloy powder to the flux. In the soldering using the solder paste, the soldering is performed so that the solder paste is printed on a portion to be soldered such as electrodes on a substrate, any components are mounted on the portion to be soldered on which the solder paste has been printed, and the substrate is heated in a heating furnace called for a “reflow furnace” to melt the solder.

As a supplying method of the solder paste, a screen-printing method or the like has been generally known but as an applying method of the solder paste to locally apply the solder paste, Japanese Patent Application Publications No. 2015-47616 disclose a technology using an air-dispensing method or a jet-dispensing method.

### SUMMARY

In the applying method by the air-dispensing method or the jet-dispensing method, any dispensable failure such as solder splashing or nozzle clogging may occur easily, which makes it difficult to stably apply the solder paste. This has been coped, up to now, with a viscosity control of arbitrary high viscosity solvent to rosin and solid solvent, a thixotropy ratio adjustment by a thixotropic agent or the like but it has been still difficult to stably apply the solder paste.

The present invention addresses such issues, and an object thereof is to provide flux and solder paste using the flux, which can be stably applied in the air-dispensing method or the jet-dispensing method.

Inventors have found out that solder paste using flux containing a solvent and a high viscosity solvent consisting of 1, 2, 6-hexantriol and isobornyl cyclohexanol can be stably applied in the air-dispensing method.

To address the issues and achieve other advantages in accordance with the object of the illustrated embodiments, in one aspect, described is flux containing a solvent, a high viscosity solvent consisting of 1, 2, 6-hexantriol and isobornyl cyclohexanol, and a thixotropic agent.

When the flux contains a solvent, a high viscosity solvent consisting of 1, 2, 6-hexantriol and isobornyl cyclohexanol, and a thixotropic agent but does not contain rosin, such flux is available for non-flux residue use.

They have also been found out that when the flux contains a solvent, a high viscosity solvent consisting of 1, 2, 6-hexantriol and isobornyl cyclohexanol, a thixotropic agent and rosin, the solder paste containing such flux can be stably applied in the jet-dispensing method in addition to the air-dispensing method.

To address the issues and achieve other advantages in accordance with the object of the illustrated embodiments, in another aspect, described is flux containing a solvent, a high viscosity solvent consisting of 1, 2, 6-hexantriol and isobornyl cyclohexanol, a thixotropic agent and rosin.

In addition, in other aspect, described is solder paste containing the above flux and metal powder.

### DETAILED DESCRIPTION

Other objects and attainments of the present invention will be become apparent to those skill in the art upon a reading of the following detailed description.

The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skill in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinally skill in the art to which the invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an” and “the” include plural referents unless the context clearly dictates otherwise.

<One Example of Flux in the Embodiments According to the Present Invention>

Flux in each of these embodiments contains a solvent, a high viscosity solvent consisting of 1, 2, 6-hexantriol (higher alcohol) and isobornyl cyclohexanol (terpene derivative), and a thixotropic agent but does not contain rosin.

In addition, flux in each of the other embodiments contains a solvent, a high viscosity solvent consisting of 1, 2, 6-hexantriol and isobornyl cyclohexanol, a thixotropic agent and rosin.

The solder paste in which metal powder is added to the flux including 1, 2, 6-hexantriol and isobornyl cyclohexanol allows its liquidity when pressurized to be improved, so that the solder paste is also able to be stably applied in the air-dispensing method, as compared with a viscosity control of arbitrary high viscosity solvent to rosin and solid solvent or a thixotropy ratio adjustment by a thixotropic agent.

When containing no rosin in the flux, the flux is available for non-flux residue use. On the other hand, when containing rosin in the flux, the solder paste containing this flux allows its liquidity when pressurized to be improved and allows its droplet shape to be stable so that the solder paste can be stably applied in the jet-dispensing method in addition to the air-dispensing method.

1, 2, 6-hexantriol is an essential component for the flux in each of these embodiments, and the solder paste containing such flux is stably applied in the jet-dispensing method and the air-dispensing method. The content of 1, 2, 6-hexantriol is 5% by mass or more and 20% by mass or less, when the total amount of the flux is estimated at 100.

Isobornyl cyclohexanol is an essential addition ingredient for the flux in each of these embodiments, and the solder paste containing such flux is stably applied in the jet-dispensing method and the air-dispensing method. The content of isobornyl cyclohexanol is 5% by mass or more and 20% by mass or less, when the total amount of the flux is estimated at 100.

As the solvent, exemplified are alcohol-based solvent, glycol ether-based solvent, glycol-based solvent, terpinols and the like. As the alcohol-based solvent, exemplified are isopropyl alcohol, 1,2-butanediol, isobornyl cyclohexanol, 2,4-diethyl-1,5-pentanediol, 2,5-dimethyl-3-hexyne-2,5-diol, 2,3-dimethyl-2,3-butanediol, 2-methylpentane-2,4-diol, 1,1,1-Tris(hydroxymethyl)propane, 2-ethyl-2-hydroxymethyl-1,3-propanediol, 2,2′-(Oxybismethylene)bis(2-ethyl-1,3-propanediol), 2,2-Bis(hydroxymethyl)-1,3-propanediol, 1,2,6-trihydroxyhexane, 1-Ethynyl-1-cyclohexanol, 1,4-Cyclohexanediol, 1,4-Cyclohexanedimethanol, 2,4,7,9-Tetramethyl-5-decyne-4,7-diol and the like. As the glycol ether-based solvent, exemplified are diethylene glycol mono-2-ethylhexyl ether, diethylene glycol monohexyl ether, diethylene glycol dibutyl ether, triethylene glycol monobutyl ether, tripropylene glycol mono methyl ether, tripropylene glycol mono butyl ether, triethylene glycol butyl methyl ether, tetraethylene glycol dimethyl ether and the like. As the glycol-based solvent, exemplified are trimethylolpropane and the like. The solvent may include a solid solvent at 25 degrees C. As the solid solvent, exemplified are 2,5-dimethyl-2,5-hexanediol, neopentyl glycol (2,2-dimethyl-1,3-propanediol), dioxane glycol and the like.

The solvent is an essential component for the flux in each of these embodiments, and the solder paste containing such flux is stably applied in the jet-dispensing method and the air-dispensing method. Any one or two species or more of these solvents may be used in the flux. The content of the solvent is 30% by mass or more and 60% by mass or less when the total amount of the flux is estimated at 100.

As the thixotropic agent, exemplified are a wax-based thixotropic agent and an amide-based thixotropic agent. As the wax-based thixotropic agent, for example, hardened caster oil is exemplified. As the amide-based thixotropic agent, exemplified are lauric acid amide, palmitic acid amide, stearic acid amide, behenic acid amide, hydroxystearic acid amide, saturated fatty acid amide, oleic acid amide, erucic acid amide, unsaturated fatty acid amide, p-toluamide (p-toluenmethane amide), aromatic amide, methylenebis stearic acid amide, ethylenebis lauric acid amide, ethylenebis hydroxystearic acid amide, saturated fatty acid bisamide, methylenebis oleic acid amide, unsaturated fatty acid bisamide, m-xylylenebis stearic acid amide, aromatic bisamide, saturated fatty acid polyamide, unsaturated fatty acid polyamide, aromatic polyamide, substituted amide, methylol stearic acid amide, methylol amide, fatty acid ester amide and the like.

The thixotropic agent is an essential component for the flux in each of these embodiments, and the solder paste containing such flux is stably applied in the jet-dispensing method and the air-dispensing method. Any one or two species or more of these thixotropic agents may be used in the flux. The content of the thixotropic agent is 7% by mass or more and 20% by mass or less when the total amount of the flux is estimated at 100.

As the rosin, for example, exemplified are natural rosins such as gum rosin, wood rosin, and tall oil rosin, and derivatives obtained from the natural rosin. As the derivatives, for example, exemplified are purified rosins, hydrogenated rosins, disproportionated rosins, polymerized rosins, acid modified rosins, phenol modified rosins, a, (3 unsaturated carboxylic acid modified products (acrylated rosins, maleated rosins, fumarated rosins, and the like), the purified products, hydrides, and disproportionated products of the polymerized rosins, the purified products, hydrides, and disproportionated products of the α,β-unsaturated carboxylic acid modified products.

The rosin is an optional component for the flux in each of these embodiments, and the solder paste containing such flux is stably applied in the jet-dispensing method. Any one or two species or more of these rosins may be used in the flux. The content of the rosin is 20% by mass or more and 40% by mass or less when the total amount of the flux is estimated at 100.

The flux in each of these embodiments may include an activator. As the activator, exemplified are an organic acid, an imidazole-based compound, organohalide and the like.

As the organic acid, exemplified are glutaric acid, adipic acid, azelaic acid, eicosane diacid, citric acid, glycolic acid, succinic acid, salicylic acid, diglycolic acid, dipicolinic acid, dibutyl aniline diglycolic acid, suberic acid, sebacic acid, thioglycol acid, terephthalic acid, dodecanedioic acid, parahydroxyphenylacetic acid, picolinic acid, phenylsuccinic acid, phtharic acid, fumaric acid, maleic acid, malonic acid, lauric acid, benzoic acid, tartaric acid, tris(2-carboxyethyl)isocyanurate, glycine, 1,3-cyclohexanedicarboxylic acid, 2,2-bis(hydroxymethyl)propionic acid, 2,2-bis(hydroxymethyl)butanoic acid, 2,3-dihydroxybenzoic acid, 2,4-diethyl glutaric acid, 2-quinolinecarboxylic acid, 3-hydroxybenzoic acid, malic acid, p-anisic acid, stearic acid, 12-hydroxystearic acid, oleic acid, linoleic acid, linolenic acid and the like.

As the imidazole-based compound, exemplified are 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[T-ethyl-4′-methylimidazolyl-(1′)]-ethyl-s-triazine, 2,4-diamino-6-[2′-methylimidazolyl-(1′)]-ethyl-s-triazine isocyanuric acid adduct, 2-phenylimidazole isocyanuric acid adduct, 2-phenyl-4,5-dihydroxymethylimidazole, 2-phenyl-4-methyl-5-hydroxymethylimidazole, 2,3-dihydro-1H-pyrrolo [1,2-a]benzimidazole, 1-dodecyl-2-methyl-3-benzylimidazolium chloride, 2-methylimidazoline, 2-phenylimidazoline, epoxy-imidazole adduct, 2-methylbenzimidazole, 2-octylbenzimidazole, 2-pentylbenzimidazole, 2-(1-ethylpentyl)benzimidazole, 2-nonylbenzimidazole, 2-(4-thiazolyl)benzimidazole, benzimidazole and the like.

As the organohalide, exemplified are 1-bromo-2-propanol, 3-bromo-1-propanol, 3-bromo-1,2-propanediol, 1-bromo-2-butanol, 1,3-dibromo-2-propanol, 2,3-dibromo-1-propanol, 1,4-dibromo-2-butanol, 2,3-dibromo-1,4-butanediol, trans-2,3-dibromo-2-buten-1,4-diol and the like.

The activator is an optional component for the flux in each of these embodiments, and the solder paste containing such flux is stably applied in the jet-dispensing method and the air-dispensing method. Any one or two species or more of these activators may be used in the flux. The content of the activator is 3% by mass or more and 10% by mass or less when the total amount of the flux is estimated at 100.

<Example of Solder Paste According to Each of the Embodiments>

The solder paste according to each of the embodiments contains any of the above-mentioned flux and metal powder. The metal powder is configured to be Sn alone, Sn—Ag based alloy, Sn—Cu based alloy, Sn—Ag—Cu based alloy, Sn—Bi based alloy, Sn—In based alloy, Sn—Pb based alloy or the like, or an alloy in which Sb, Bi, In, Cu, Zn, As, Ag, Cd, Fe, Ni, Co, Au, Ge, P, Pb or the like is added to any of these alloys. However, it is preferable that the metal powder is solder which does not contain Pb.

<Effects of Flux and Solder Paste According to Each of the Embodiments>

In the application of the solder paste by the air-dispensing method or the jet-dispensing method, it may be important to flow the solder paste rapidly when pressurized in order to restrain any nozzle clogging. In addition, it may be important to keep stable a shape of droplet of the solder paste when jet-dispensing it in order to allow the stable application of the solder paste in the jet-dispensing method. In the jet-dispensing method, it may be also important to apply a droplet of the solder paste to an object to be applied such as a substrate so that a tail portion of the droplet of the solder paste is not broken in order to restrain the solder paste from scattering when applying the solder paste onto the object to be applied.

Accordingly, by using the flux containing a solvent, a high viscosity solvent consisting of 1, 2, 6-hexantriol and isobornyl cyclohexanol and the thixotropic agent, the solder paste using this flux allow its liquidity when pressurized to be improved. The solder paste is also able to be more stably applied in the air-dispensing method, as compared with a viscosity control of arbitrary high viscosity solvent to rosin and solid solvent or a thixotropy ratio adjustment by a thixotropic agent.

When containing no rosin in the flux, the flux is available for non-flux residue use. On the other hand, when containing rosin in the flux, the solder paste containing this flux allows its liquidity when pressurized to be improved and allows a shape of its droplet to be stable so that the solder paste can be stably applied in the jet-dispensing method in addition to the air-dispensing method.

### Executed Examples

The flux of each of the Executed Examples and the Comparative Examples was prepared with each of the compositions shown in following Table 1 and the solder paste was also prepared by using the flux. The application properties of the solder paste were then verified. The solder paste using the flux which contains the rosin was verified on the application properties in both of the air-dispensing method and jet-dispensing method. The solder paste using the flux which contains no rosin was verified on the application properties in only the air-dispensing method. The composition rates in Table 1 have been expressed in % by mass when the total amount of the flux is estimated at 100.

When applying the solder paste in the air-dispensing method, the solder paste contained flux in an amount of 11% by mass and metal powder in an amount of 89% by mass. When applying the solder paste in the jet-dispensing method, the solder paste contained flux in an amount of 15% by mass and metal powder in an amount of 85% by mass. The metal powder in the solder paste was the powder of Sn—Ag—Sn based solder alloy including Ag in an amount of 3.0% by mass, Cu in an amount of 0.5% by mass, and the reminder of Sn. A diameter of the metal powder was 5 μm through 15 μm.

<Evaluation Result of Application Properties of Solder Paste in Air-Dispensing Method>

(1) Verification Method

The solder paste using the flux of each of the Executed Examples and the solder paste using the flux of each of the Comparative Examples were applied by the air dispensers to multilayer substrates in each of which Cu is covered on a grass epoxy board. 60,000 shots of the solder paste in each of the Executed and Comparative Examples were continuously applied and then, their application properties were determined. Their determination results were carried out on the basis of the following criterion of determination. An inner diameter of the needle or nozzle in each of the air dispensers is preferably 0.1 mm or more and 1.5 mm or less but was 0.35 mm in this verification. An application pressure is preferably 80 kpa or more and 200 kpa or less but was 100 kpa in this verification. A period of application time is preferably 80 mmsec or more and 500 mmsec or less but was 100 mmsec in this verification. Application temperature was 25 degrees C. in this verification. An optimum value of a clearance between the nozzle and the substrate changes based on a discharged amount of the solder paste but was 0.2 mm in this verification.

(2) Criterion for Determination

◯: The stable application amount of the solder paste was successively obtained.

Δ: The stable application amount of the solder paste was not obtained.

x: The stable application amount of the solder paste was not obtained and an end transfer part thereof occurred.

<Evaluation Result of Application Properties of Solder Paste in Jet-Dispensing Method>

(1) Verification Method

The solder paste using the flux of each of the Executed Examples and the solder paste using the flux of each of the Comparative Examples were applied by the jet dispensers to multilayer substrates in each of which Cu is covered on a grass epoxy board. As the jet dispensers, piezo type jet printers were used. 100,000 shots of the solder paste in each of the Executed and Comparative Examples were continuously applied and then, their application properties were determined. Their determination results were carried out on the basis of the following criterion of determination.

(2) Criterion for Determination

◯: All patters by the solder paste were applied on their target positions.

x: A positional displacement or missing by the solder paste occurred or frequently occurred. Otherwise, the solder paste was not issued from the dispenser.

TABLE 1

| | | EXECUTED | EXECUTED | EXECUTED | EXECUTED | EXECUTED | EXECUTED |
|---|---|---|---|---|---|---|---|
| | | EXAMPLE 1 | EXAMPLE 2 | EXAMPLE 3 | EXAMPLE 4 | EXAMPLE 5 | EXAMPLE 6 |
| ROSIN | Acid modified rosin | 25 | | | | | |
| | Polymerized rosin | | 28 | 22 | | | |
| SOLVENT | Diethylene glycol | 49.8 | 36.5 | 29.5 | | | |
| | monohexyl ether | | | | | | |
| | Diethylene glycol | | | | 10 | | 29 |
| | dibutyl ether | | | | | | |
| | Trimethylolpropane | | | | 16 | 18 | 21 |
| | 2,5-dimethyl- | | | | 16 | 17 | |
| | 2,5-hexanediol | | | | | | |
| | 2,2-dimethyl- | | | | 15 | 17 | |
| | 1,3-propanediol | | | | | | |
| HIGH | 1, 2, 6-hexantriol | 5 | 11 | 18 | 15 | 20 | 10 |
| VISCOSITY | Isobornyl | 5 | 13 | 18 | 8 | 8 | 20 |
| SOLVENT | cyclohexanol | | | | | | |
| THIXOTROPIC | Stearic acid amide | 5 | 3 | 3 | 8 | 8 | 8 |
| AGENT | Hardened caster oil | 2 | 4 | 5 | | | |
| | p-toluamide | | | | 12 | 12 | 12 |
| ACTIVATOR | Succinic acid | 2.5 | 1 | 1 | | | |
| | Glutaric acid | 5 | 1 | 1 | | | |
| | Azelaic acid | | 1 | 1 | | | |
| | 2-phenylimidazole | 0.2 | 1 | 1 | | | |
| | Trans-2,3-dibromo- | 0.5 | 0.5 | 0.5 | | | |
| | 2-buten-1,4-diol | | | | | | |
| TOTAL | | 100 | 100 | 100 | 100 | 100 | 100 |
| EVALUATION | AIR-DISPENSING | ◯ | ◯ | ◯ | ◯ | ◯ | ◯ |
| RESULT | METHOD | | | | | | |
| | JET-DISPENSING | ◯ | ◯ | ◯ | — | — | — |
| | METHOD | | | | | | |

| | | COMPARATIVE | COMPARATIVE | COMPARATIVE | COMPARATIVE |
|---|---|---|---|---|---|
| | | EXAMPLE 1 | EXAMPLE 2 | EXAMPLE 3 | EXAMPLE 4 |
| ROSIN | Acid modified rosin | 30 | | | |
| | Polymerized rosin | | 23 | | |
| SOLVENT | Diethylene glycol | 34.8 | 44.5 | | |
| | monohexyl ether | | | | |
| | Diethylene glycol | | | 14 | 25 |
| | dibutyl ether | | | | |
| | Trimethylolpropane | | | 18 | 15 |
| | 2,5-dimethyl- | | | 17 | 15 |
| | 2,5-hexanediol | | | | |
| | 2,2-dimethyl- | | | 16 | 10 |
| | 1,3-propanediol | | | | |
| HIGH | 1, 2, 6-hexantriol | 20 | | 15 | |
| VISCOSITY | Isobornyl | | 20 | | 15 |
| SOLVENT | cyclohexanol | | | | |
| THIXOTROPIC | Stearic acid amide | 5 | 3 | 8 | 8 |
| AGENT | Hardened caster oil | 2 | 5 | | |
| | p-toluamide | | | 12 | 12 |
| ACTIVATOR | Succinic acid | 2.5 | 1 | | |
| | Glutaric acid | 5 | 1 | | |
| | Azelaic acid | | 1 | | |
| | 2-phenylimidazole | 0.2 | 1 | | |
| | Trans-2,3-dibromo- | 0.5 | 0.5 | | |
| | 2-buten-1,4-diol | | | | |
| TOTAL | | 100 | 100 | 100 | 100 |
| EVALUATION | AIR-DISPENSING | Δ | X | X | Δ |
| RESULT | METHOD | | | | |
| | JET-DISPENSING | X | X | — | — |
| | METHOD | | | | |

The flux of each of the Executed Examples 1 through 3 contained 1, 2, 6-hexantriol and isobornyl cyclohexanol as the high viscosity solvents in a respective amount of 5% by mass or more and 20% by mass or less in a range limited by the present invention, but did not contain any other high viscosity solvents. This flux also contained diethylene glycol monohexyl ether as the solvent in an amount of 30% by mass or more and 60% by mass or less in a range limited by the present invention, stearic acid amide and hardened caster oil as the thixotropic agent in a total amount of 7% by mass or more and 20% by mass or less in a range limited by the present invention, and acid modified rosins or polymerized rosins as the rosins in an amount of 20% by mass or more and 40% by mass or less in a range limited by the present invention. This flux further contained a predetermined combination of succinic acid, glutaric acid and azelaic acid as the organic acid, 2-phenylimidazole as the imidazole-based compound, and trans-2,3-dibromo-2-buten-1,4-diol as the organohalide, as the activator, in a total amount of 3% by mass or more and 10% by mass or less in a range limited by the present invention. The solder paste using the flux of each of the Executed Examples 1 through 3 showed that the stable application amount of the solder paste was successively obtained in the air-dispensing method and all patters by the solder paste were applied on their target positions in the jet-dispensing method. It is said desired that this flux or the solder paste using this flux has attained desired application properties in both of the air-dispensing method and the jet-dispensing method.

The flux of the Executed Example 4 contained 1, 2, 6-hexantriol and isobornyl cyclohexanol as the high viscosity solvents in a respective amount of 5% by mass or more and 20% by mass or less in a range limited by the present invention. This flux also contained a combination of diethylene glycol dibutyl ether and trimethylolpropane, and 2,5-dimethyl-2,5-hexanediol and 2,2-dimethyl-1,3-propanediol, which were the solid solvents, as the solvent in a total amount of 30% by mass or more and 60% by mass or less in a range limited by the present invention. This flux further contained a combination of stearic acid amide and p-toluamide as the thixotropic agent in a total amount of 7% by mass or more and 20% by mass or less in a range limited by the present invention. This flux, however, did not contain any activators nor rosins. The solder paste using the flux of the Executed Example 4 showed that the stable application amount of the solder paste was successively obtained in the air-dispensing method. It is said desired that this flux or the solder paste using this flux has attained desired application properties in the air-dispensing method.

The flux of the Executed Example 5 contained 1, 2, 6-hexantriol and isobornyl cyclohexanol as the high viscosity solvents in a respective amount of 5% by mass or more and 20% by mass or less in a range limited by the present invention. This flux also contained trimethylolpropane, and 2,5-dimethyl-2,5-hexanediol and 2,2-dimethyl-1,3-propanediol, which were the solid solvents, as the solvent in a total amount of 30% by mass or more and 60% by mass or less in a range limited by the present invention. This flux further contained a combination of stearic acid amide and p-toluamide as the thixotropic agent in a total amount of 7% by mass or more and 20% by mass or less in a range limited by the present invention. This flux, however, did not contain any activators nor rosins. The solder paste using the flux of the Executed Example 5 showed that the stable application amount of the solder paste was successively obtained in the air-dispensing method. It is said desired that this flux or the solder paste using this flux has attained desired application properties in the air-dispensing method.

The flux of the Executed Example 6 contained 1, 2, 6-hexantriol and isobornyl cyclohexanol as the high viscosity solvents in a respective amount of 5% by mass or more and 20% by mass or less in a range limited by the present invention. This flux also contained a combination of diethylene glycol dibutyl ether and trimethylolpropane as the solvents in a total amount of 30% by mass or more and 60% by mass or less in a range limited by the present invention. This flux further contained a combination of stearic acid amide and p-toluamide as the thixotropic agent in a total amount of 7% by mass or more and 20% by mass or less in a range limited by the present invention. This flux, however, did not contain any activators and rosins. The solder paste using the flux of the Executed Example 6 showed that the stable application amount of the solder paste was successively obtained in the air-dispensing method. It is said that this flux or the solder paste using this flux has attained desired application properties in the air-dispensing method.

The flux of each of the Executed Examples 4 through 6 did not contain any rosins so that the flux was available for non-flux residue use, which was not described in the evaluation result.

On the other hand, the flux of the Comparative Example 1 contained 1, 2, 6-hexantriol as the high viscosity solvent in an amount of 20% by mass in a range limited by the present invention, but did not contain isobornyl cyclohexanol. This flux contained the solvents, the thixotropic agents, the rosins and the activators in a range limited in the present invention. The solder paste using the flux of the Comparative Example 1 showed that the stable application amount of the solder paste was not obtained in the air-dispensing method and a positional displacement or missing by the solder paste occurred in the jet-dispensing method. It is said that this flux or the solder paste using this flux does not satisfy any desired application properties but shows some application properties in the air-dispensing method even if the flux contained the solvents, the thixotropic agents, the rosins and the activators in a range limited in the present invention. It is also said that this flux or the solder paste using the flux, however, does not have attained any desired application properties in the jet-dispensing method.

The flux of the Comparative Example 2 contained isobornyl cyclohexanol as the high viscosity solvent in an amount of 20% by mass in a range limited by the present invention, but did not contain 1, 2, 6-hexantriol. This flux contained the solvents, the thixotropic agents, the rosins and the activators in a range limited in the present invention. The solder paste using the flux of the Comparative Example 2 showed that the stable application amount of the solder paste was not obtained and an end transfer part thereof occurred in the air-dispensing method and a positional displacement or missing by the solder paste occurred in the jet-dispensing method. It is said that this flux or the solder paste using this flux has not attained the stable application amount of the solder paste in both of the air-dispensing method and the jet-dispensing method, even if the flux contained the solvents, the thixotropic agents, the rosins and the activators in the flux in a range limited in the present invention.

The flux of the Comparative Example 3 contained 1, 2, 6-hexantriol as the high viscosity solvent in an amount of 15% by mass in a range limited by the present invention, but did not contain isobornyl cyclohexanol. This flux contained the solvents and the thixotropic agents in a range limited in the present invention but did not contain the rosins and the activators. The solder paste using the flux of the Comparative Example 3 showed that the stable application amount of the solder paste was not obtained and an end transfer part thereof occurred in the air-dispensing method. It is said that this flux or the solder paste using this flux has not attained the stable application amount of the solder paste in the air-dispensing method, even if the flux contained the solvents and the thixotropic agents in a range limited in the present invention.

The flux of the Comparative Example 4 contained isobornyl cyclohexanol as the high viscosity solvent in an amount of 15% by mass in a range limited by the present invention, but did not contain 1, 2, 6-hexantriol. This flux contained the solvents and the thixotropic agents in a range limited in the present invention but did not contain the rosins and the activators. The solder paste using the flux of the Comparative Example 4 showed that the stable application amount of the solder paste was not obtained in the air-dispensing method. It is said that this flux or the solder paste using this flux does not satisfy desired application properties but shows some application properties in the air-dispensing method even if the flux contained the solvents and the thixotropic agents in a range limited in the present invention and this flux or the solder paste using this flux does not show the desired application properties in the jet-dispensing method.

From the above, use of the flux containing a solvent, a high viscosity solvent consisting of 1, 2, 6-hexantriol and isobornyl cyclohexanol and a thixotropic agent and use of the solder paste using this flux allow the solder paste to be stably applied in the air-dispensing method, as compared with a viscosity control of arbitrary high viscosity solvent to rosin and solid solvent or a thixotropy ratio adjustment by a thixotropic agent.

When containing no rosin in the flux, the flux is available for non-flux residue use.

In addition, use of the flux containing a solvent, a high viscosity solvent consisting of 1, 2, 6-hexantriol and isobornyl cyclohexanol, a thixotropic agent and rosin and use of the solder paste using this flux allow the solder paste to be stably applied in the jet-dispensing method in addition to the air-dispensing method.

Even when the flux of the present invention contains any one or a combination of an organic acid, an imidazole-based compound and organohalide as an activator, any applicability by the high viscosity solvent consisting of 1, 2, 6-hexantriol and isobornyl cyclohexanol is not inhibited, so that the stable application of the solder paste is well attained.

It is to be noted that any technical scope of the claims and/or meaning of term(s) claimed in the claims are not limited to the description in the above-mentioned embodiments. It should be understood by those skilled in the art that various modifications, combinations, sub-combinations and alternations may occur depending on design requirements and other factors insofar as they are within the scope of the appended claims or the equivalents thereof.

1. A flux, comprising:
a solvent
a high viscosity solvent consisting of 1, 2, 6-hexantriol and isobornyl cyclohexanol; and
a thixotropic agent, excluding rosin.

2. A flux comprising:
a solvent;
a high viscosity solvent consisting of 1, 2, 6-hexantriol and isobornyl cyclohexanol;
a thixotropic agent; and
rosin.

3. The flux according to claim 1, wherein the flux contains 1, 2, 6-hexantriol in an amount of 5% by mass or more and 20% by mass or less and isobornyl cyclohexanol in an amount of 5% by mass or more and 20% by mass or less.

4. The flux according to claim 2, wherein the flux contains 1, 2, 6-hexantriol in an amount of 5% by mass or more and 20% by mass or less and isobornyl cyclohexanol in an amount of 5% by mass or more and 20% by mass or less.

5. The flux according to claim 2, wherein the flux contains the rosin in an amount of 20% by mass or more and 40% by mass or less.

6. The flux according to claim 4, wherein the flux contains the rosin in an amount of 20% by mass or more and 40% by mass or less.

7. The flux according to claim 1, wherein the flux contains the solvent in an amount of 30% by mass or more and 60% by mass or less.

8. The flux according to claim 2, wherein the flux contains the solvent in an amount of 30% by mass or more and 60% by mass or less.

9. The flux according to claim 1, wherein the flux contains the thixotropic agent in an amount of 7% by mass or more and 20% by mass or less.

10. The flux according to claim 2, wherein the flux contains the thixotropic agent in an amount of 7% by mass or more and 20% by mass or less.

11. The flux according to claim 1, further comprising an activator in an amount of 3% by mass or more and 10% by mass or less.

12. The flux according to claim 2, further comprising an activator in an amount of 3% by mass or more and 10% by mass or less.

13. Solder paste comprising the flux according to claim 1 and metal powder.

14. Solder paste comprising the flux according to claim 2 and metal powder.
